(19) United States
(12) Patent Application Publication
(10) Pub. No.: US 2026/0355642 A1
(43) Pub. Date: Nov. 12, 2026

(54) AI Angel Doll Cellphones

(71) Applicant: Amber Cole, Winthrop, ME (US)

(72) Inventor: Amber Cole, Winthrop, ME (US)

(21) Appl. No.: 19/200,347

(22) Filed: May 6, 2025

(51) Int. Cl. A63H 3/00; A63H 3/28; A63H 3/46; A63H 13/00; A63H 27/00; H04B 1/3888

(52) U.S. Cl. CPC A63H 3/003; A63H 3/28; A63H 3/46; A63H 13/005; A63H 27/008; H04B 1/3888; A63H 2200/00

(57) ABSTRACT

The disclosure can recognize different users of the device and match the settings for each user. The device has the capability to take photographs, call for help or relay verbal messages and fly. All joints can move and function increasing its mobility and productivity. A pair of flapping wings sustains the robot in guided flight similar to a humming bird including hovering and directional flight. A central processor unit (CPU) and a graphics processor unit (GPU) are capable of a machine learning and an artificial intelligence AI via a sense of sight, hearing, smelling and a sense of touch in the robot. Furthermore, an intrinsic memory has instructions for following a user via the guided flight for learning the user's daily routines, needs, activities and requests. An extrinsic memory includes an iterative machine learning from the CPU and the GPU during the user's daily routines, needs, activities and requests.

### BACKGROUND

Cellphones are used for lots of different reasons across the globe. As technology advances, so does the productivity of this product. More than a few ventures have concentrated on bringing cell phones to the younger and adolescent market but without any appreciable market share. Android and Apple operating systems are not geared toward children users though in many ways they seek to have intuitive functions. Security is also an issue with children using cellphones so either functions have to be limited or extra safeguards must be put into place. There have been no products available as original equipment or as an aftermarket to address this problem.

On the other hand, bringing Artificial Intelligence to the toy market is also a work in progress and also commercially viable. Small dolls and animals with rudimentary Artificial Intelligence are learning vehicles for children and adolescents. It is well known that children learn best while at play and the power of the imagination helps open a young mind to new learning experiences. Cost is less an issue in the present market than in the past as price points have been established and the smart toy market share has expanded. There have been no products available as original equipment or as an aftermarket to address this problem either.

### SUMMARY OF THE INVENTION

The AI Angel Doll Cellphone increases productivity in communication. AI Angel Doll Cellphones combine artificial intelligence and cellphone technologies to aid in productivity and utility. AI Angel doll cellphones are a fun way to provide traditional phone capabilities with artificial intelligence technology into a small child like toy.

A robot comprises a pair of flapping wings configured to sustain the robot in guided flight similar to a humming bird comprising hovering and directional flight. A body resembles a doll attached to the pair of flapping wings and comprising a head, a torso, a pair of shoulders, a pair of arms, a pair of hands, a pair of legs, a pair of feet, and a pair of hips. A central processor unit (CPU) and a graphics processor unit (GPU) capable of a machine learning and an artificial intelligence AI via a sense of sight, a sense of hearing, a sense of smelling and a sense of touch are included in the robot. Furthermore, an intrinsic memory in the body has intrinsic instruction for following a user via the guided flight for learning a user's daily routines, needs, activities and requests. An extrinsic memory also in the body comprises the machine learning from the intrinsic instructions and an iterative machine learning from the CPU and the GPU during the user's daily routines, needs, activities and requests.

### BRIEF DESCRIPTION OF THE DRAWINGS

FIG. 1 is a front pictorial view of the AI Angel Doll Cellphone in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

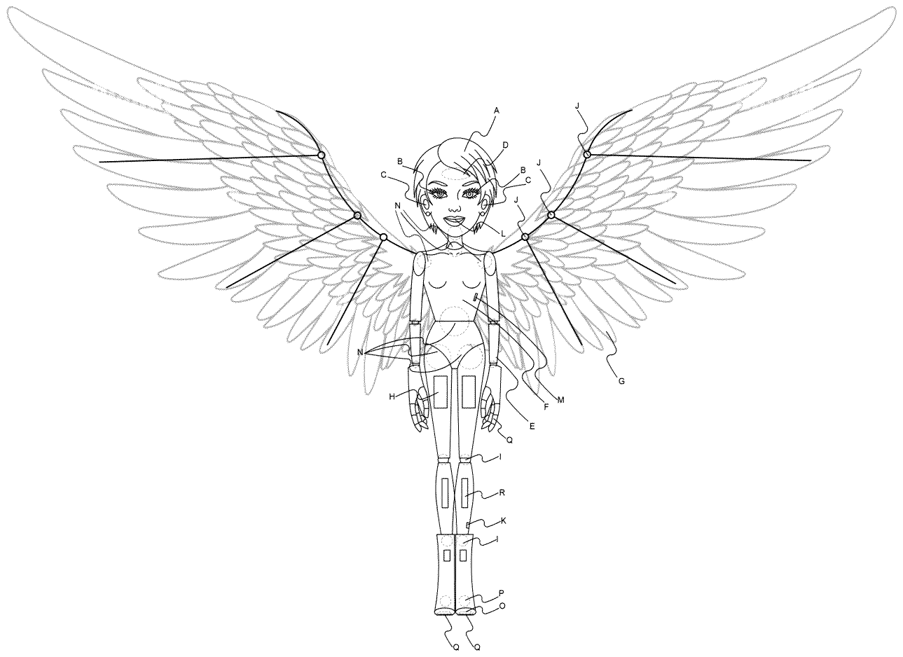

FIG. 1 is a Front perspective view of the AI Angel Doll Cellphone showing: Robot software storage as A, Eyeball are fluid movable orbs to see as B, Auditory hearing as C, Programming Storage as D, Flash Light as E, Hollow body for wiring storage as F, Solar power synthetic feathers as G, RAM storage as H, Joints as I, Flexible joints in wings for function as J, USB port as K, Moving lips as L, Sim card slot as M, Roll Ballads socket joints to allow movement as N, Hinge Joint for Toes as O, Ball of Foot as P, Cushing Padding for Grip and Balance as Q, Extra sound output for music as R, in accordance with an embodiment of the present disclosure.

The present disclosed communication device, also known as “AI Angel Doll Cellphone,” offers a fun spin on your traditional Cellphone. Using artificial intelligence and modern robotic engineering it builds on today's cellphones. Able to receive calls, the AI Angel Doll Cellphone will also use AI technology to cater to the needs of the user making it a hands-free device. The device looks like a child doll and offers customizable looks to encourage use. Just like a normal cellphone it uses radio frequencies while the user is in a telephone service area to receive and send messages or call. It also can take pictures and has a flash light built in if needed. Using a built-in sensor, it will also be able to recognize different users and change settings based on the user.

The disclosure provides users with a flying AI companion robot. With advancements in drones, AI and robots growing rapidly in recent years, many individuals are seeking new ways to incorporate AI into their daily lives. The disclosure provides a landscape rich for opportunities in how computerized technologies can be utilized. The disclosure offers a modern compact and miniaturized AI model that combines AI into a movable and a trainable companion robot that can speak, complete chores/tasks, make and receive calls, track alarm and/or appointment dates, fly to rest on the owner/operator's shoulder, and/or travel beside them, in addition to a host of other expansive features.

The disclosure is an independent moving robot that can fly alongside its human as it possesses movable wings and joints while employing peripheral vision for direction control. Solar powered and defined by sim card and software storage coding, the robots personality can be easily programmed allowing for life-like device to understand users and communicate with them through voice commands. Furthermore, the disclosure is developed to act as a companion in times of loneliness, offering the option of being a male or a female presenting robot, in order to foster connection and aide in overall user well-being. The disclosure distinguishes over conventional and commercially available products in how robots engage with the human population while also supporting mental health.

The disclosure is not necessarily a hummingbird but more like hop, jump, leap and glide, fly and climb device that sees and hears. It can hang with moving fingers. No scents are necessary and it doesn't have to have moving lips and eyes. Embodiments include be a screen face using augmented reality and virtual reality to navigate the humanoid world.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A robot comprising: a pair of flapping wings configured to sustain the robot in guided flight similar to a humming bird comprising hovering and directional flight; a body resembling a doll attached to the pair of flapping wings and comprising a head, a torso, a pair of shoulders, a pair of arms, a pair of hands, a pair of legs, a pair of feet, and a pair of hips; a central processor unit (CPU) and a graphics processor unit (GPU) capable of a machine learning and an artificial intelligence AI via a sense of sight, a sense of hearing, a sense of smelling and a sense of touch; an intrinsic memory in the body comprising intrinsic instruction for following a user via the guided flight for learning a user's daily routines, needs, activities and requests; and an extrinsic memory also in the body comprising the machine learning from the intrinsic instructions and an iterative machine learning from the CPU and the GPU during the user's daily routines, needs, activities and requests.

2. The robot of claim 1, wherein the pair of flapping wings comprise solar absorbing synthetic feathers over a sustaining structure of flexible joints and hollow phalanges.

3. The robot of claim 1, wherein the head further comprises a pair of eyes configured to provide the sense of sight to the robot.

4. The robot of claim 1, wherein the head further comprises a set of ears configured to provide the sense of hearing to the robot.

5. The robot of claim 1, wherein the head further comprises a moving mouth and speaker for communication.

6. The robot of claim 1, wherein the head further comprises a nose configured to provide the sense of smelling to the robot.

7. The robot of claim 1, wherein the body further comprises a plurality of touch receptors in the pair of hands, the pair of feet, the legs, the pair of arms and the head.

8. The robot of claim 1, wherein the body further comprises servo motors configured to move the pair of flapping wings, the head, the torso, the pair of shoulders, the pair of arms, the pair of hands, the pair of legs, the pair of feet, and the pair of hips.

9. The robot of claim 1, further comprising a battery configured to store an electrical power via solar absorbing synthetic feathers on the flapping wings.

10. The robot of claim 1, further comprising a battery configured to store an electrical power input from a USB (Universal Serial Bus) port.

11. The robot of claim 1, wherein the intrinsic memory comprises a preconfigured state machine logic and a programmable logic for a given set of conditions including the user's daily routines, needs, activities and requests.

12. The robot of claim 1 wherein the extrinsic memory comprises a non-volatile and programmable electronic memory.

13. The robot of claim 1, wherein the robot develops AI characteristics via a daily interaction between the robot and the user.

14. The robot of claim 13, further comprising an imprinting circuit configure to bond the user to the robot via the AI characteristics.

15. The robot of claim 1, further comprising an imprinting circuit configured to bond the robot to the user via a plurality of characteristics of the intrinsic memory.
